(19) United States
(12) Patent Application Publication
(10) Pub. No.: US 2019/0198004 A1
(43) Pub. Date: Jun. 27, 2019

(54) METHOD AND DEVICE FOR CHANGING THE NOISE EMISSION OF AN ENTRANCE SYSTEM FOR A RAIL VEHICLE, ENTRANCE SYSTEM, AND RAIL VEHICLE

(71) Applicant: KNORR-BREMSE GESELLSCHAFT MIT BESCHRÄNKTER HAFTUNG, Mödling (AT)

(72) Inventors: Peter JETZINGER, Enns (AT); Thomas WITZELNIG, Biberbach (AT)

(21) Appl. No.: 16/329,681

(22) PCT Filed: Aug. 31, 2017
(86) PCT No.: PCT/EP2017/071883

§ 371 Date: Feb. 28, 2019

(30) Foreign Application Priority Data
Sep. 1, 2016 (DE) 10 2016 116 320.1

(51) Int. Cl. G10K 11/178

(52) U.S. Cl. CPC G10K 11/178; G10K 2210/1283

(57) ABSTRACT

The invention relates to a method for changing the noise emission of an entrance system for a rail vehicle, wherein in an excitation step at least one partial region of the entrance system is actively vibrationally excited by means of an excitation signal in order to at least partially compensate the noise emission.

### CROSS REFERENCE AND PRIORITY CLAIM

This patent application is a U.S. National Phase of International patent application Ser. No. PCT/EP2017/071883, filed Aug. 31, 2017, which claims priority to German patent application Ser. No. 10 2016 116 320.1, filed Sep. 1, 2016, the disclosure of which being incorporated herein by reference in their entireties.

### FIELD

Disclosed embodiments relate to a method for changing a sound emission of an entry system for a rail vehicle, to a device for changing a sound emission of an entry system for a rail vehicle, to an entry system for a rail vehicle and to a rail vehicle.

### BACKGROUND

A door of a rail vehicle acts as a passive sound source which irradiates sounds from an outer side of the door to an inner side of the door at least in a damped fashion. In order to reduce the transmission of sound from the outer side to the inner side, a mass of the door can be increased. Likewise, sound damping material can be arranged between the outer side and the inner side.

### SUMMARY

Disclosed embodiments are directed to making available an improved method for changing a sound emission of an entry system for a rail vehicle, an improved device for changing a sound emission of an entry system for a rail vehicle, an improved entry system and an improved rail vehicle.

Disclosed embodiments achieve this by a method for changing a sound emission of an entry system for a rail vehicle, a device for changing a sound emission of an entry system for a rail vehicle, an entry system having the device and a rail vehicle having the entry system.

### BRIEF DESCRIPTION OF THE FIGURES

Exemplary embodiments of the approach presented here are illustrated in the drawings and explained in more detail in the following description. In the drawings:

FIG. 1 shows an illustration of a rail vehicle having an entry system according to an exemplary embodiment;

FIG. 2 shows a block diagram of a device for changing a sound emission of an entry system according to an exemplary embodiment; and

FIG. 3 shows a flowchart of a method for changing a sound emission of an entry system of a rail vehicle according to an exemplary embodiment.

### DETAILED DESCRIPTION

Sounds are propagated by means of sound waves. Sound waves cause vibrations at an interface. The vibrations can be at least partially extinguished by counter-vibrations in the opposite direction. The counter-vibrations can be generated by a vibration generator which is coupled to the vibrating interface.

In the approach presented here, a partial region of an entry system which is capable of vibrating, for example, an external skin of a door leaf, is coupled to an electrically operated vibration generator. If the partial region is excited to vibrate by sound waves, the vibration generator inputs counter-vibrations into the partial region. The counter-vibrations at least partially extinguish the vibrations. Without vibrations, the partial region does not emit any sound waves and a transmission of sound is prevented.

As a result of the vibration generator, damping material and mass for damping can be dispensed with. For example, a door leaf of the entry system presented here can be implemented in a lightweight design. The lightweight design reduces a mass inertia of the movable part. A smaller drive power is then required to move the door leaf. Alternatively, high dynamics can be achieved with the same drive power.

A method for changing a sound emission of an entry system for a rail vehicle is represented, wherein in an excitation operation at least one partial region of the entry system is actively excited to vibrate, using an excitation signal, in order to at least partially compensate the sound emission.

A sound emission is understood to be an irradiation of sound waves from an interface or a surface. Sound waves are emitted if the interface or surface vibrates. A partial region can comprise an entry system surface which is capable of vibrating. An excitation signal can be an electrical signal. The excitation signal can predefine an amplitude and frequency of the vibration which is input. The vibration which is input and a vibration which is the cause of the sound emission can at least partially extinguish one another.

The method can comprise a determining operation in which the excitation signal is determined using an immission signal. The vibration which is input can be dependent on an exciting vibration. More comprehensive extinguishing of the vibrations in the partial region can therefore be achieved.

In the determining operation, an amplitude of the excitation signal can be determined in the opposite direction to an amplitude of the immission signal. The vibration which is input can be an anti-vibration which is analogous to anti-sound.

The method can comprise an operation of detecting the immission signal, wherein a sound immission and/or vibration immission which is the cause of the sound emission acting on the entry system is detected using a detection apparatus, coupled to the entry system, in order to obtain the immission signal. A sound immission can be sound waves acting on the partial region. A vibration immission can be vibrations which are input into the partial region by means of solid-borne sound. As a result of direct processing of the exciting immission, the excitation signal can be adapted to the immission.

In the excitation operation, at least one partial region of a door leaf of the entry system can be excited. A door leaf can have large surfaces which are capable of vibrating.

In the excitation operation, an outer face of the door leaf can be excited. The outer face or outer wall of the door leaf is subjected directly to sound waves from the surroundings. If the vibrations of the outer face are reduced, less sound is transported into the rail vehicle.

In the excitation operation, at least one part of the housing component of a drive component of the entry system can be excited. A drive component can irradiate sound which is undesired in the passenger compartment of the rail vehicle. The sound emission of the drive component is known and can be input, for example as an anti-sound, into the housing component, in order to extinguish the sound of the drive component.

Furthermore, a device for changing a sound emission of an entry system for a rail vehicle is presented, wherein the device has an excitation apparatus which is designed to actively excite at least one partial region of the entry system to vibrate, using an excitation signal, in order to at least partially compensate the sound emission.

The excitation apparatus can have at least one piezo-element and/or one electrodynamic vibrator for converting the excitation signal into a vibration. Piezo-elements have a high excitation speed and are particularly suitable for high-frequency vibrations. Electrodynamic vibrations have a relatively low excitation speed and are particularly suitable for medium-frequency and low-frequency vibrations.

In addition, an entry system for a rail vehicle having a device according to the approach presented here is presented.

Furthermore, a rail vehicle having an entry system according to the approach presented here is presented.

In the following description of advantageous exemplary embodiments, identical or similar reference symbols are used for the elements which are illustrated and act similarly in the various figures, wherein a repeated description of these elements is dispensed with.

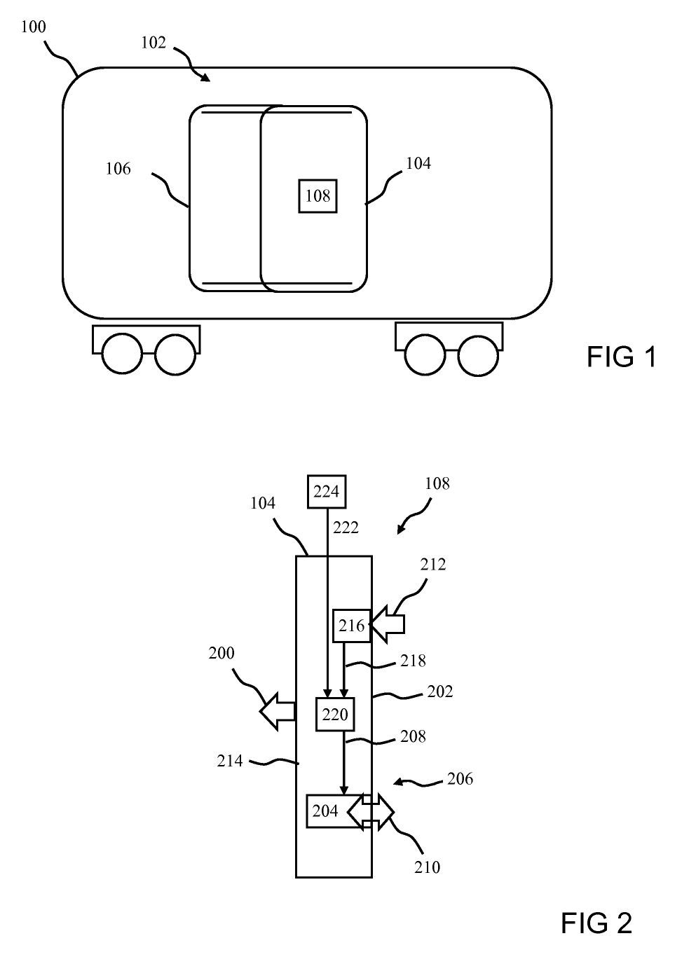

FIG. 1 shows an illustration of a rail vehicle 100 with an entry system 102 according to an exemplary embodiment. The entry system 102 is here a sliding entry door system 102 with a door leaf 104 which, in a closed position, closes a portal 106 of the entry system 102. If the portal 106 is closed, the door leaf 104 separates a passenger compartment of the rail vehicle 100 from an exterior space of the rail vehicle 100. The door leaf 104 is coupled to a changing device 108 according to an exemplary embodiment.

Sound waves of sounds in the exterior space, such as for example a driving sound of the rail vehicle 100 or sounds from adjacent rail vehicles, impact on the door leaf 104. At the door leaf 104, an outer face of the door leaf 104 is excited to vibrate by the sound waves. The vibrations of the outer face cause in turn sound waves in the subsequent media, which sound waves in turn excite the inner face of the door leaf to vibrate. The vibrations of the outer face are also transmitted directly to the inner face by solid-borne sound via connecting points between the outer face and the inner face. The vibrations of the inner face cause air-borne sound in the air of the passenger compartment.

The vibrations of the inner face or outer face can be damped passively by a high mass. The sound waves between the inner face and the outer face can be damped by damping material in the intermediate space.

Here, the inner face and/or the outer face are/is coupled to the device 108. The device 108 is designed to actively change a sound emission of the entry system 102. For this purpose, at least one partial region of the inner face and/or one partial region of the outer face is excited to vibrate, using an electrical excitation signal, in order to at least partially compensate the vibrations causing the sound emission. In this context, the vibrations, which are induced by the device 108, are in the opposite direction to the vibrations excited by the sound waves and at least partially extinguish them. The inner face and/or the outer face therefore vibrate, at least in the partial region, with a reduced amplitude, and as a result of which the sound level of the irradiated sound waves is significantly reduced. In particular, the sound level in frequency ranges of the induced vibration can be below a perception threshold.

FIG. 2 shows a block diagram of a device 108 for changing a sound emission 200 of an entry system according to an exemplary embodiment. The device 108 corresponds here essentially to the device in FIG. 1. Here, the device 108 is coupled to an outer face 202 of the door leaf 104. An excitation apparatus 204 is coupled to a partial region 206 of the outer face 202 and excites the partial region 206 to vibrate, using an electrical excitation signal 208. The vibration 210 at least partially compensates a vibration of the outer face 202 which is caused by a sound immission 212 on the outer face 202. As a result, the outer face 202 vibrates to a significantly smaller degree than without the compensating vibration 210.

Since the outer face 202 has little vibration, only a small vibration is also transmitted to an inner face 214 of the door leaf 104, and the sound emission 200 of the inner face 214 is low. The device 108 can, of course, also be applied to the inner face 214. The principle remains as described above, but the device 108 acts on the inner side and not on the outer side. Of course, the device 108 can be applied in parallel both on the inner side and on the outer side.

The excitation apparatus 204 can have, for example, a piezo-element which reacts to a change in voltage of the excitation signal 208 with a change in length. The change in length brings about a displacement of a mass of the excitation apparatus 204. Owing to the mass inertia of the mass, a force acts on the outer face 202 here. The piezo-element is particularly suitable for high frequencies.

Likewise, the excitation apparatus 204 can have an electrodynamic vibrator which reacts to a change in a current flow of the excitation signal 208 with a change in an attraction force or repulsion force acting on a mass which is capable of vibrating. Owing to the mass inertia of the mass, a force likewise acts on the outer face 202 here.

In an exemplary embodiment, the excitation signal 208 is determined as a function of the sound immission 212. For this purpose, the device 108 has a detection apparatus 216. The detection apparatus 216 forms the sound immission 212 in an immission signal 218. The immission signal 218 is used in a determining apparatus 220 to determine the excitation signal 208. The sound immission 212 represents, for example, an interference variable in a closed-loop control circuit of the apparatus 220. In order to detect the sound immission 212, the detection apparatus 216 can have a sound pickup or a microphone. The sound pickup can model the sound immission 212 in the immission signal 218 by means of a suitable element which is capable of vibrating. The sound pickup can also be arranged at a distance from the entry system.

The detection apparatus 216 can likewise model the actual vibration of the outer face 202 in the immission signal 218. For this purpose, the detection apparatus 216 can have, for example, a vibration pickup, such as an acceleration sensor. The vibration pickup can be coupled to the outer face 202 and can model an actual vibration of the outer face 202 in the immission signal 218. The immission signal 218 can then be used as feedback in the closed-loop control circuit. In order to be able to determine the actual irradiated air-borne sound 200, it is also possible to apply a further detection apparatus to the inner face 214 of the door leaf. This has the further advantage that adjustment to the minimum sound emission 200 can be carried out independently of the property of the door leaf.

In one exemplary embodiment, the excitation signal 208 is determined using a sound signal 222. The sound signal 222 models here a known sound of the rail vehicle and/or of the entry system. For example, the sound signal 222 can model a sound of a drive apparatus of the entry system. The sound signal 222 is stored here in a memory apparatus 224 and is made available when the sound to be compensated is emitted.

In the determining apparatus 220, the immission signal 218 and the sound signal 222 can be used simultaneously to determine the excitation signal 208.

In other words, in FIG. 2 active air-borne signal damping of a rail vehicle door leaf 104 is illustrated. The approach represented here improves the air-borne sound damping of a door leaf design in that the movement of a door leaf 104, for example the outer side, is actively influenced.

The rail vehicle door leaf 104 separates two spaces from one another. By means of air-borne sound 212 in a space, the rail vehicle door leaf 104 is excited to vibrate and as a result generates air-borne sound 200 in the second space. Here, a force which is directed counter to the generated vibration is applied to the rail vehicle door leaf 104 by, for example, piezo-elements and a suitable control means. By superimposing the two vibrations, the movement of the rail vehicle door leaf 104 is damped or stopped completely and as a result little to no air-borne sound 200 is irradiated.

The air-borne sound damping between the outer region and the passenger compartment of the rail vehicle, and vice versa, is improved. As a result, in rail vehicle door leaves 104, a general improvement of the sound damping can be achieved.

In one exemplary embodiment, at least one sound source which is undesired on the entry system, such as for example a gear mechanism housing and/or a motor housing, is actively damped, in order to reduce the sound emission of this component.

The active sound damping or damping is carried out by force application by means of piezo-elements and/or electrodynamic vibrators or shakers. The force application takes place in a defined force application direction, or with a defined force application form by means of shear stress, torque and/or tensile stress.

In the determining apparatus 220, different control algorithms such as, for example, a linear control about a working point or a non-linear control can be used. Likewise, various control strategies such as broadband suppression, suppression of the natural frequencies and/or suppression of the two-shell elements, for example of the mass-spring-mass resonance frequency or detuning of the coincidence frequency can be applied.

The force application elements 204 or vibration application elements 204 can be positioned in a variable fashion. The power supply of the force application elements 204 or vibration application elements 204 can be provided via a signal line or a bus line.

The sensor system 216 for the purpose of control can have additional piezo-elements or strain gauges DMS.

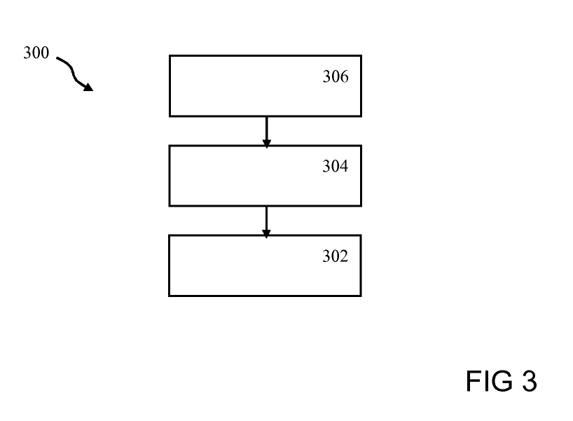

FIG. 3 shows a flowchart of a method 300 for changing a sound emission of an entry system of a rail vehicle according to an exemplary embodiment. The method 300 has an excitation operation 302 in which at least one partial region of the entry system is actively excited to vibrate, using an excitation signal, in order to at least partially compensate the sound emission.

In one exemplary embodiment, the method has a determining operation 304 in which the excitation signal is determined using an immission signal.

In the determining operation 304, an amplitude of the excitation signal can be determined in the opposite direction to an amplitude of the immission signal.

In a detection operation 306, the immission signal can be detected. In this context, a sound immission and/or vibration immission which is the cause of the sound emission, acting on the entry system, is detected using a detection apparatus which is coupled to the entry system, in order to obtain the immission signal.

If an exemplary embodiment comprises an “and/or” conjunction between a first feature and a second feature, this is to be understood as meaning that the exemplary embodiment according to the embodiment has both the first feature and the second feature, and according to a further embodiment has either only the first feature or only the second feature.

### LIST OF REFERENCE NUMBERS

100 Rail vehicle
102 Entry system
104 Door leaf
106 Portal
108 Changing device
200 Sound emission
202 Outer face
204 Excitation apparatus
206 Partial region
208 Excitation signal
210 Vibration
212 Sound immission
214 Inner face
216 Detection apparatus
218 Immission signal
220 Determining apparatus
222 Sound signal
224 Memory apparatus
300 Changing method
302 Excitation operation
304 Determining operation
306 Detection operation

1. A method for changing a sound emission of an entry system for a rail vehicle, the method comprising:
actively exciting at least one partial region of the entry system to vibrate, using an excitation signal to at least partially compensate for the sound emission.

2. The method of claim 1, further comprising determining the excitation signal using an immission signal.

3. The method of claim 2, wherein, during determining an amplitude of the excitation signal is determined in a direction opposite to an amplitude of the immission signal.

4. The method of claim 2, further comprising detecting the immission signal, wherein a sound immission and/or vibration immission which is a cause of the sound emission acting on the entry system is detected using a detection apparatus coupled to the entry system to obtain the immission signal.

5. The method of claim 1, wherein the exciting the at least one partial region excites a door leaf of the entry system.

6. The method of claim 5, wherein an outer face of the door leaf is excited.

7. The method of claim 1 wherein the exciting the at least one partial region excites at least one part of a housing of a drive component of the entry system.

8. A device for changing a sound emission of an entry system for a rail vehicle, the device comprising:
an excitation apparatus configured to actively excite at least one partial region of the entry system to vibrate, using an excitation signal to at least partially compensate for the sound emission.

9. The device of claim 8, wherein the excitation apparatus has at least one piezo-element and/or one electrodynamic vibrator for converting the excitation signal into a vibration.

10. An entry system for a rail vehicle having a device as claimed in claim 8.

11. A rail vehicle having an entry system as claimed in claim 10.

12. The device of claim 8, wherein the excitation signal is determined using an immission signal.

13. The device of claim 12, wherein, during the determining includes determining an amplitude of the excitation signal in a direction opposite to an amplitude of the immission signal.

14. The device of claim 12, further comprising a detection apparatus coupled to the entry system, wherein a sound immission and/or vibration immission which is a cause of the sound emission acting on the entry system is detected to obtain the immission signal.

15. The device of claim 8, wherein the exciting the at least one partial region excites a door leaf of the entry system.

16. The device of claim 15, wherein an outer face of the door leaf is excited.

17. The device of claim 8, wherein the exciting the at least one parrtial region excites at least one part of a housing of a drive component of the entry system.
